(19) United States
(12) Patent Application Publication
(10) Pub. No.: US 2009/0109858 A1
(43) Pub. Date: Apr. 30, 2009

(54) Communication Quality Determining Apparatus, Communication Quality Determining Method and Its Program

(75) Inventors: Yasuhiro Yamasaki, Tokyo (JP); Hideyuki Shimonishi, Tokyo (JP)

Correspondence Address: FOLEY AND LARDNER LLP;SUITE 500, 3000 K STREET NW, WASHINGTON, DC, 20007, US

(73) Assignee: NEC CORPORATION, Tokyo (JP)

(21) Appl. No.: 11/922,336

(22) PCT Filed: Jul. 7, 2006
(86) PCT No.: PCT/JP2006/313576

§ 371 Date: Dec. 17, 2007

(30) Foreign Application Priority Data
Jul. 15, 2005 (JP) 2005-206292

(51) Int. Cl. H04L 12/26

(52) U.S. Cl. 370/242

(57) ABSTRACT

A communication quality determining apparatus for receiving or intercepting data sent from a transmission side to a reception side en route of its transmission, and determining its communication quality. The apparatus includes a deciding unit for making a decision on whether an input packet is to be acquired. The apparatus also includes an estimating unit for, by comparing information on an acquired packet predicted based on an acquired packet acquired based on a result of the decision with information on an actually acquired packet, estimating communication quality of a session that the acquired packet belongs to.

### TECHNICAL FIELD

The present invention relates to a technique for determining the quality of a network.

### BACKGROUND ART

The present invention is directed to an apparatus and a method for determining the quality of a network. As used herein, the term “quality of a network” refers to “packet loss.”

Conventionally, there are techniques for determining the quality of a network including the following methods:

### RELATED ART 1

A first related art is one described in Patent Document 1, “Quality Monitoring System for Multimedia Communications and Quality Monitoring Method Therefor.” A determining method in this art for a “packet loss” will now be explained with reference to FIGS. 1, 2 and 3.

FIG. 1 is a diagram showing a mode of application of the Related Art 1.

The quality of communication between communication terminals 10 and 20 is monitored by a determining apparatus 30. Although the determining apparatus is shown to be connected to the communication terminal 10 in FIG. 1, it may be connected to the communication terminal 20. Moreover, the determining apparatus 30 may be disposed anywhere a packet during communication can be observed, and determination may be made in a network using a network node such as a router/switch or the like in the network or a TAP (an apparatus that copies packets) for determination use.

The first art is a method achieved by the determining apparatus 30 that determines the quality of a network in a communication system for data communication using RTP (Real Time Protocol) between the communication terminals 10 and 20.

Its configuration will now be explained.

FIG. 2 is a block diagram showing a configuration with a determining apparatus 30a according to the first art.

The determining apparatus 30a of the first art is comprised of a data capturing section 101 for copying and acquiring a packet during communication in a network, a flow identifying section 102 for identifying a flow of the packet acquired in the data capturing section 101, a flow information storage section 103 for storing flow-identified data on a flow-by-flow basis, an SN (Sequence Number) difference calculating section 201a for checking an SN based on the flow information to detect a missing SN, an occurrence-of-differences calculating section 202a for storing the number of occurrences of decision that a missing SN is found at the SN difference calculating section 201a, an observed-point loss information storage section 301a for storing a result of the decision made by the occurrence-of-differences calculating section 202a on a flow-by-flow basis, and a quality result display section 302a for displaying the result.

In the first art, data flowing through a network is captured by the determining apparatus 30a.

The packet input to the determining apparatus 30a is first received at the data capturing section 101. The data received at the data capturing section 101 is passed to the flow identifying section 102. The flow identifying section 102 identifies a flow based on header information including MAC address, IP address, TCP port number, UDP port number, protocol ID, VLAN, MPLS, etc. The flow identifying section 102 accumulates results of the flow identification into the flow information storage section 103, which serves as a database having the results classified on a flow-by-flow basis.

Triggered by a command or timing or the like for quality determination, the SN difference calculating section 201a sorts the data in the flow information storage section 103 by SN of an RTP packet for each flow.

Once a discontinuous SN is located, a decision that a packet is lost is made, missing SN's are counted, and the count is added to a value in the occurrence-of-differences calculating section 202a. After the processing at the SN difference calculating section 201a and occurrence-of-differences calculating section 202a have been applied to all packets subjected to quality determination, the content of the occurrence-of-differences calculating section 202a is stored as a packet loss count without further processing or as a packet loss rate calculated according to EQ. (1), in the observed-point loss information storage section 301a on a flow-by-flow basis. Each time the information is recorded, the value of the occurrence-of-differences calculating section 202a is reset to zero.

[Equation for Calculating a Packet Loss Rate]

Packet loss rate=(Value in the occurrence-of-differences calculating section 202a/(Max. of SN−Min. of SN))×100 (1)

Triggered by a command from a user or timing or the like, the quality result display section 302a displays the flow-by-flow packet loss information stored in the observed-point loss information storage section.

Next, an operation will be explained.

FIG. 3 shows processing flow at the determining apparatus 30a according to the first art.

In the determining apparatus 30a of the first art, processing is activated each time a packet is input, whereupon packet capturing processing is conducted at the packet capturing section 101. The processing is processing A-1. After this processing is completed, the process moves to processing A-2.

At the processing A-2, flow identification is conducted on the input packet at the flow identifying section 102. The flow identification is made based on header information of the packet including MAC address, IP address, TCP port number, UDP port number, protocol ID, VLAN, MPLS, etc., and a result thereof is stored into the flow information storage section 103.

Processing A-3 is started being trigged by a command or timing or the like for quality determination. Upon the start of the processing, the process moves to processing A-4.

At the processing A-4, the packets stored on a flow-by-flow basis in the flow information storage section 103 are sorted by SN of RTP by the SN difference calculating section 201a, thereby checking whether a missing SN is found. If a missing SN is found, the process moves to processing A-5. If no missing SN is found, the process moves to processing A-6.

At the processing A-5, the number of missing SN's counted at the processing A-4 is added to a total number of missing SN's counted thus far in the occurrence-of-differences calculating section 202a. After this processing, the process moves to the processing A-6.

At the processing A-6, a decision is made as to whether the SN check processing has been applied to all packets in a packet stream currently subjected to quality determination. If the check processing has been completed for all packets, the process moves to processing A-7. If the check processing has not been completed for all packets yet, the process goes back to the processing A-4.

At the processing A-7, the value in the occurrence-of-differences calculating section 202a is used as a packet loss count, and the calculation according to EQ. (1) is performed using it to determine a packet loss rate, which is recorded in the observed-point loss information storage section 301a. After the recording processing, the count of the occurrence-of-differences calculating section 202a is reset to zero, and the processing is terminated.

The packet loss count or packet loss rate in the observed-point loss information storage section in this system represents the number or rate of packets lost in the network from the packet transmitting terminal to the determining instrument.

### RELATED ART 2

A second related art is one described in Patent Document 2, “Packet Loss Determination System.” A “packet loss” determining method according to this art will now be explained with reference to FIGS. 4, 5 and 6.

FIG. 4 is a diagram showing a mode of application of this art. The quality of communication between communication terminals 10 and 20 is monitored in observers 40 observing packets in a network. Although the number of the observers 40 is shown to be three in FIG. 4, any number no less than one may be employed. Moreover, the observers 40 may be disposed anywhere a packet during communication can be observed, and determination may be made in a network using a network node such as a router/switch or the like in the network or a TAP (an apparatus that copies packets) for determination use. The observers 40 pass results of observation of communication to a determination server 50.

The second art is a method for determining the quality of a network at the determination server 50 based on information from the observers 40 in a communication system for data communication between the communication terminals 10 and 20.

Next, a configuration of the second art will be explained.

FIG. 5 is a block diagram showing a configuration with an observer 40b and a determination server 50b according to the second art.

The observer 40b of the second art is comprised of a data capturing section 101 for copying and acquiring a packet during communication in a network, a flow identifying section 102 for identifying a flow of the packet acquired in the data capturing section 101, a flow information storage section 103 for storing flow-identified data on a flow-by-flow basis, and a packet number counting section 201b for checking the content in the flow information storage section 103, counting the number of packets in the same flow, and transmitting the result to the determination server 50b.

The determination server 50b of the second art is comprised of an observer identifying section 104 for receiving information sent from the observer 40b and identifying which observer 40b the information comes from, a packet number storage section 303b for managing the packet number on an observer-by-observer/flow-by-flow basis, a packet number comparing section 304b for comparing the packet numbers in the same flow in the packet number storage section 303b between the observers, an observed-segment loss information storage section 301b for calculating an index regarding a loss between the observers from the result of the comparison of the packet numbers, and a quality result display section 302b for displaying the result.

In the second art, data flowing through a network is captured by the observer 40b. The packet input to the observer 40b is first received at the data capturing section 101.

The data capturing section 101 performs bridge processing on an incoming packet, copies the packet itself or part thereof, that is, for example, only the header information section of the packet, and passes the information to the flow identifying section 102.

The flow identifying section 102 identifies a flow based on the header information including MAC address, IP address, TCP port number, UDP port number, protocol ID, VLAN, MPLS, etc. The flow identifying section 102 accumulates results of the flow identification into the flow information storage section 103, which serves as a database having the results classified on a flow-by-flow basis.

Triggered by a command or timing or the like for observation, the packet number counting section 201b counts the number of packets in the same flow from the data in the flow information storage section 103, and transmits the result to the determination server 50b using communication means such as a network. The network used at that time may be a dedicated line or a general line carrying other traffic.

The determination server 50b receives the information on passing-through packets for each flow from one or more observers 40b present in the network. The incoming information into the determination server 50b is first received at the observer identifying section 104 for deciding which observer the information comes from. After the decision, the information is classified on an observer-by-observer/flow-by-flow basis and stored in the packet number storage section 303b.

Triggered by a command or timing or the like for quality determination, the packet number comparing section 304b compares the packet numbers for the same flow between the observers for quality observation, and checks whether any difference is made according to EQ. (2) below. The value from EQ. (2) represents the number of packet losses occurring between the observers being compared, and the value can be further divided by the passing amount to determine a packet loss rate. After calculating the index regarding a loss using EQ. (2), the index is stored in the observed-segment loss information storage section 301b.

[Equation for Calculating Observed-Segment Loss Information for a Flow C in a Segment Between Observers A and B (Assuming that both the Observers A and B are Present in the Course of the Flow C)]

Packet loss count=|Packet number of flow C passing through observer A−Packet number of flow C passing through observer B| (2)

Triggered by a command from a user or timing or the like, the quality result display section 302b displays the flow-by-flow packet loss information stored in the observed-segment loss information.

Next, an operation will be explained.

FIG. 6 shows processing flow at the observer 40b and determination server 50b according to the second art.

At the observer 40b of the second art, processing is activated each time a packet is input, whereupon packet capturing processing is conducted at the packet capturing section 101. The processing is processing B-1. After this processing is completed, the process moves to processing B-2.

At the processing B-2, flow identification is conducted on the input packet at the flow identifying section 102. The flow identification is made based on header information of the packet including MAC address, IP address, TCP port number, UDP port number, protocol ID, VLAN, MPLS, etc., and a result thereof is stored into the flow information storage section 103. After this processing is completed, the process moves to processing B-3.

At the processing B-3, the number of packets in the same flow is incremented at the packet number counting section 201b, and the process moves to processing B-4.

At the processing B-4, the information on the incremented packet number is transmitted to the determination server 50b. The network used at that time may be a dedicated line or a general line carrying other traffic. After this processing is completed, the process moves to processing B-5.

At the processing B-5, the probe identifying section 104 identifies which observer the information on the incoming packet number in a flow comes from, and the information is stored on an observer-by-observer/flow-by-flow basis into the packet number storage section 303b.

Processing B-6 is started being triggered by a command or timing or the like for quality determination. Upon the start of the processing, the process moves to processing B-7.

At the processing B-7, the calculation according to EQ. (2) is performed at the packet number comparing section 304b to obtain information on losses between the observers at which quality is desired to be known, and the result is stored in the observed-segment loss information storage section 301b.

The packet loss count or packet loss rate in the observed-segment loss information storage section in this system represents the number or rate of packets lost in the network between the observers being compared.

### RELATED ART 3

A configuration of a third related art will be explained hereinbelow.

The third art is a common related art.

A mode of application of this art is shown in FIG. 4. The quality of communication between communication terminals 10 and 20 is monitored at observers 40 observing packets in a network. Although the number of the observers 40 is shown to be three in FIG. 4, any number no less than one may be employed. Moreover, the observers 40 may be disposed anywhere a packet during communication can be observed, and determination may be made in a network using a network node such as a router/switch or the like in the network or a TAP (an apparatus that copies packets) for determination use. The observers 40 pass results of observation of communication to a determination server 50.

The third related art is a method for determining the quality of a network at the determination server 50 based on information from the observers 40 in a communication system for data communication between the communication terminals 10 and 20.

Next, an operation will be explained.

FIG. 7 is a block diagram showing a configuration with an observer 40c and a determination server 50c according to the third related art.

The observer 40c of the third related art is comprised of a data capturing section 101 for copying and acquiring a packet during communication in a network.

Moreover, the determination server 50b of the third related art is comprised of an observer identifying section 104 for receiving transmitted data from the data capturing section and identifying which observer 40c the information comes from, a flow identifying section 102 for identifying which flow the information belongs to, a flow information storage section 103c for storing flow-identified information on an observer-by-observer/flow-by-flow basis, a quality calculating section 200c for calculating an index regarding a loss, such as number or rate of packets lost in the network from a packet transmitting terminal to the observer 40c, and a quality decision/display section 300c for calculating an index regarding a loss, such as number or rate of packets lost in the network between the designated observers.

In the third related art, data flowing through a network is captured by the observer 40c. The packet input to the observer 40c is first received at the data capturing section 101.

The data capturing section 101 performs bridge processing on an incoming packet, copies the packet itself or part thereof, for example, only the header information section of the packet, and passes the information to the determination server 50c. The network used at that time may be a dedicated line or a general line carrying other traffic.

After receiving the data from the observer 40c, the determination server 50c initially identifies which observer 40c the information comes from in the observer identifying section 104.

Subsequent to the observer identification, flow identifying processing for identifying which flow the data of interest belongs to based on header information including MAC address, IP address, TCP port number, UDP port number, protocol ID, VLAN, MPLS, etc., is performed in the flow identifying section 102. After the flow identifying processing, the packet is classified based on observer/flow and stored in the flow information storage section 103c.

The quality calculating section 200c performs the processing equivalent to that at the quality calculating section 200a of the aforementioned first method to calculate an index regarding a loss, such as number or rate of packets lost in the network to the observer 40c from a packet transmitting terminal.

The quality decision/display section 300c performs the processing equivalent to that at the quality decision/display section 300b of the aforementioned second method to calculate an index regarding a loss, such as number or rate of packets lost in the network between the observers being compared.

Next, an operation of the third related art will be explained.

FIG. 8 shows processing flow at the observer 40c and determination server 50c according to the third related art.

In the observer 40c of the third related art, processing is activated each time a packet is input, whereupon packet capturing processing is conducted at the packet capturing section 101. The processing is processing C-1. After this processing is completed, the process moves to processing C-2.

At the processing C-2, the captured packet or its header information is extracted, and is transmitted to the determination server 50c. After this processing, the process moves to processing C-3.

At the processing C-3, the observer identifying section 104 identifies the packet information sent from the observer 40c as to which observer has sent the information, and the information is classified on an observer-by-observer basis. After this processing, the process moves to processing C-4.

At the processing C-4, flow identification is conducted on the input packet at the flow identifying section 102. The flow identification is made based on header information of the packet including MAC address, IP address, TCP port number, UDP port number, protocol ID, VLAN, MPLS, etc., and a result of the identification is classified on an observer-by-observer/flow-by-flow basis, and a result thereof is stored in the flow information storage section 103c.

Processing C-5 is started being trigged by a command or timing or the like for quality determination. Upon the start of the processing, the process moves to processing C-6.

At the processing C-6, an index regarding a loss, such as number or rate of packets lost in the network to the observer 40c from the packet transmitting terminal, is calculated by the quality calculating section 200c, and another index regarding a loss, such as number or rate of packets lost in the network between the observers being compared, is calculated by the quality decision/display section 300c.

While the observer identifying processing is made before the flow identifying processing in this explanation, the order may be reversed.

A first problem is that the aforementioned first technique, second technique and third technique require high computational capability to determine the quality of a flow.

A reason thereof is that according to the aforementioned first technique, second technique and third technique, processing such as missing SN check or packet numbering must be applied to all packets in a flow to be determined. Thus, the number of packets to be calculated is enormous in a high-speed network, and since all such packets must be processed, high computational capability is required.

A second problem is that, in a case that whole packets in a flow to be determined cannot be acquired, the aforementioned first technique, second technique and third technique cannot accurately determine the quality, including an index regarding a loss, such as number or rate of packets lost in a network to the observer 40c from the packet transmitting terminal, or an index regarding a loss, such as number or rate of packets lost in the network between the observers.

A reason thereof is that according to the aforementioned first technique, second technique and third technique, the packet loss count is simply defined as number of duplicated ACK numbers. Thus, in a case that duplicated ACK numbers are actually present but duplicated packets cannot be acquired, no packet loss is counted. Hence, the quality cannot be accurately determined.

A third problem is that the aforementioned second technique is costly in implementing the whole quality determination system.

A reason thereof is that the aforementioned second technique requires a flow information storage section or equivalent processing section for retaining the condition (packet SN or time) for every flow and for every observer. Thus, the number of flow management information sections increases in proportion to an increased number of observers, hence increasing the implementation cost for the whole quality determination system.

A fourth problem is that according to the aforementioned third technique, the data traffic between the observer and the determination server is increased.

A reason thereof is that according to the aforementioned third technique, a packet or packet header per se is sent from the observer to the determination server. Since quality determination processing is performed at the determination server, it is necessary to pass all information on packets passing through observers, instead of compiled information (such as packet number or packet loss count), to the determination server.

[Patent Document 1] JP-2004-289748A

[Patent Document 2] JP-2002-152266A

### DISCLOSURE OF THE INVENTION

### Problems to be Solved by the Invention

The present invention has been made in view of the aforementioned problems, and its objective is to provide a quality determination system capable of determining the quality in terms of a loss such as “packet loss” or “packet loss rate” during communication even with low computational processing capability.

Another objective of the present invention is to provide a quality determination system capable of calculating an index regarding a loss even in a case that not all packets to be determined can be acquired.

Still another objective of the present invention is to provide a quality determination system capable of calculating an index regarding a loss even with low implementation cost.

Still another objective of the present invention is to provide a quality determination system capable of reducing the communication traffic between a determination server and an observer.

Yet still another objective of the present invention is to affirm performance degradation or a change in quality by comparing indices regarding the quality such as “throughput” or “packet loss” calculated among a plurality of observers, even with low implementation cost.

### Means for Solving the Problems

A first invention for solving the aforementioned problems is a communication quality determining apparatus for, by receiving or intercepting data sent from a transmission side to a reception side en route of its transmission, determining its communication quality, characterized in comprising:

deciding unit for making a decision on whether an input packet is to be acquired; and

estimating unit for, by comparing information on an acquired packet predicted based on an acquired packet acquired based on a result of said decision with information on an actually acquired packet, estimating communication quality of a session that said acquired packet belongs to.

A second invention for solving the aforementioned problems is a communication quality determining apparatus for, by receiving or intercepting data sent from a transmission side to a reception side en route of its transmission, determining its communication quality, characterized in comprising:

identifying unit for identifying a protocol that an input packet belongs to;

deciding unit for making a decision on whether said input packet is to be acquired based on said identified protocol; and

estimating unit for, by comparing information on an acquired packet acquired based on a result of said decision with information on an actually acquired packet, estimating communication quality of a session that said acquired packet belongs to solely from said acquired packet.

A third invention for solving the aforementioned problems is, in the aforementioned first or second invention, characterized in that:

said estimating unit is configured to estimate, as communication quality, a data loss count, a data loss rate, continuity of data loss, a data loss number, a predicted range of a data loss count, a throughput, a predicted range of a throughput, a delay time, a variation in delay or a distribution of delay for each session.

A fourth invention for solving the aforementioned problems is, in the aforementioned second or third invention, characterized in that:

said identifying unit is configured to identify TCP, UDP/RTP or a protocol containing sequence information in header information.

A fifth invention for solving the aforementioned problems is, in any one of the aforementioned first to fourth inventions, characterized in that:

said deciding unit is configured to decide whether an input packet is to be acquired using sequence information contained in header information of the input packet.

A sixth invention for solving the aforementioned problems is, in the aforementioned fifth invention, characterized in that:

said deciding unit is configured to have a decision function for deriving a packet acquisition deciding value using a function, pseudo random numbers or a result of looking-up of a table, with an argument of said sequence information, and to decide whether a packet is to be acquired by comparing a value of said decision function and a predefined decision threshold.

A seventh invention for solving the aforementioned problems is, any one of the aforementioned first to sixth inventions, characterized in that:

said estimating unit is configured to calculate a throughput using a difference in acquisition time and a difference in sequence information between a packet acquired in the past and a packet acquired thereafter.

An eighth invention for solving the aforementioned problems is, any one of the aforementioned first to seventh inventions, characterized in that:

said estimating unit is configured to, with respect to specific sequence information, calculate a data loss count or a data loss rate by calculating sequence information of a packet to be acquired next from a decision function given to said protocol, and comparing said sequence information with that of an actually acquired new packet.

A ninth invention for solving the aforementioned problems is, in any one of the aforementioned first to eighth inventions, characterized in that:

said estimating unit is configured to obtain a conditional probability that, with respect to a certain discarded packet, a subsequent packet away from said discarded packet by N of sequence information is discarded, using statistics of a difference between sequence information of a packet decided to be discarded in the past and that of a packet decided to be discarded thereafter.

A tenth invention for solving the aforementioned problems is, in any one of the aforementioned first to ninth inventions, characterized in that:

said estimating unit is configured to obtain an error range of a data loss count or a throughput using at least one of the number of samples, an observation period and a sampling probability, based on an actually occurring data loss count.

An eleventh invention for solving the aforementioned problems is, in any one of the aforementioned first to tenth inventions, characterized in that:

a plurality of said deciding unit or said estimating unit are provided;

said deciding unit has transmitting unit for transmitting a part of a copy, header information or payload information of a decided and acquired packet to said estimating unit; and

said estimating unit is configured to estimate communication quality of a session that the acquired packet belongs to from said transmitted acquired packet or from information associated with said acquired packet.

A twelfth invention for solving the aforementioned problems is, in the aforementioned eleventh invention, characterized in that:

said deciding unit is configured to unite a plurality of acquired packets or information associated therewith into one packet.

A thirteenth invention for solving the aforementioned problems is, in the aforementioned eleventh or twelfth invention, characterized in that:

said estimating unit is configured to specify a segment in which packet discarding has occurred by comparing deciding unit that could acquire a packet having sequence information and deciding unit that could not acquire a packet having sequence information.

A fourteenth invention for solving the aforementioned problems is, in any one of the aforementioned eleventh to thirteenth inventions, characterized in that:

said estimating unit is configured to determine a delay time between specific deciding unit by obtaining a delay time obtained by certain deciding unit from a packet having certain sequence information and a delay time obtained by other deciding unit from said packet, and comparing them.

A fifteenth invention for solving the aforementioned problems is, in any one of the aforementioned eleventh to fourteenth inventions, characterized in that:

said estimating unit is configured to, depending upon an amount of acquired packets transmitted from certain deciding unit, command a change of a decision function or a decision threshold in said deciding unit.

A sixteenth invention for solving the aforementioned problems is, in any one of the aforementioned eleventh to fifteenth inventions, characterized in that:

said estimating unit is configured to, upon detection of a change in quality at certain deciding unit, command a change of a decision function or a decision threshold to said deciding unit or other deciding unit.

A seventeenth invention for solving the aforementioned problems is a communication quality determining method of, by receiving or intercepting data sent from a transmission side to a reception side en route of its transmission, determining its communication quality, characterized in comprising:

a deciding step of making a decision on whether an input packet is to be acquired; and

an estimating step of, by comparing information on an acquired packet predicted based on an acquired packet acquired based on a result of said decision with information on an actually acquired packet, estimating communication quality of a session that said acquired packet belongs to.

An eighteenth invention for solving the aforementioned problems is a communication quality determining method of, by receiving or intercepting data sent from a transmission side to a reception side en route of its transmission, determining its communication quality, characterized in comprising:

an identifying step of identifying a protocol that an input packet belongs to;

a deciding step of making a decision on whether said input packet is to be acquired based on said identified protocol; and

an estimating step of, by comparing information on an acquired packet acquired based on a result of said decision with information on an actually acquired packet, estimating communication quality of a session that said acquired packet belongs to solely from said acquired packet.

A nineteenth invention for solving the aforementioned problems is, in the aforementioned seventeenth or eighteenth invention, characterized in that:

said estimating step is a step of estimating, as communication quality, a data loss count, a data loss rate, continuity of data loss, a data loss number, a predicted range of a data loss count, a throughput, a predicted range of a throughput, a delay time, a variation in delay or a distribution of delay for each session.

A twentieth invention for solving the aforementioned problems is, in the aforementioned eighteenth or nineteenth invention, characterized in that:

said identifying step is a step of identifying TCP, UDP/RTP or a protocol containing sequence information in header information.

A twenty-first invention for solving the aforementioned problems is, in any one of the aforementioned seventeenth to twentieth inventions, characterized in that:

said deciding step is a step of deciding whether an input packet is to be acquired using sequence information contained in header information of the input packet.

A twenty-second invention for solving the aforementioned problems is, in the aforementioned twenty-first invention, characterized in that:

said deciding step has a deriving step of deriving a packet acquisition deciding value using a function, pseudo random numbers or a result of looking-up of a table, with an argument of said sequence information, and is a step of deciding whether a packet is to be acquired by comparing a derived value of said decision function and a predefined decision threshold.

A twenty-third invention for solving the aforementioned problems is, in any one of the aforementioned seventeenth to twenty-second inventions, characterized in that:

said estimating step is a step of calculating a throughput using a difference in acquisition time and a difference in sequence information between a packet acquired in the past and a packet acquired thereafter.

A twenty-fourth invention for solving the aforementioned problems is, in any one of the aforementioned seventeenth to twenty-third inventions, characterized in that:

said estimating step is a step of, with respect to specific sequence information, calculating a data loss count or a data loss rate by calculating sequence information of a packet to be acquired next from a decision function given to said protocol, and comparing said sequence information with that of an actually acquired new packet.

A twenty-fifth invention for solving the aforementioned problems is, in any one of the aforementioned seventeenth to twenty-fourth inventions, characterized in that:

said estimating step is a step of obtaining a conditional probability that, with respect to a certain discarded packet, a subsequent packet away from said discarded packet by N of sequence information is discarded, using statistics of a difference between sequence information of a packet decided to be discarded in the past and that of a packet decided to be discarded thereafter.

A twenty-sixth invention for solving the aforementioned problems is, in any one of the aforementioned seventeenth to twenty-fifth inventions, characterized in that:

said estimating step is a step of obtaining an error range of a data loss count or a throughput using at least one of the number of samples, an observation period and a sampling probability, based on an actually occurring data loss count.

A twenty-seventh invention for solving the aforementioned problems is, in any one of the aforementioned seventeenth to twenty-sixth inventions, characterized in that:

said deciding step has a transmitting step of transmitting a part of a copy, header information or payload information of a packet acquired at a plurality of points; and

said estimating step is a step of estimating communication quality of a session that the acquired packet belongs to from said transmitted acquired packet or from information associated with said acquired packet.

A twenty-eighth invention for solving the aforementioned problems is, in the aforementioned twenty-seventh invention, characterized in that:

said deciding step is configured to unite a plurality of acquired packets or information associated therewith into one packet.

A twenty-ninth invention for solving the aforementioned problems is, in the aforementioned twenty-seventh or twenty-eighth invention, characterized in that:

said estimating step is a step of specifying a segment in which packet discarding has occurred by comparing a point at which a packet having sequence information could be acquired and a point at which a packet having sequence information could not be acquired.

A thirtieth invention for solving the aforementioned problems is, in any one of the aforementioned twenty-seventh to twenty-ninth inventions, characterized in that:

said estimating step is a step of determining a delay time in a specific segment by obtaining a delay time obtained at a certain point from a packet having certain sequence information and a delay time obtained at other point from said packet, and comparing them.

A thirty-first invention for solving the aforementioned problems is, in any one of the aforementioned twenty-seventh to thirtieth inventions, characterized in that:

said estimating step has a step of, depending upon an amount of acquired packets transmitted from a certain point, commanding a change of a decision function or a decision threshold at said point.

A thirty-second invention for solving the aforementioned problems is, in any one of the aforementioned twenty-seventh to thirtieth inventions, characterized in that:

said estimating step has a step of, upon detection of a change in quality at a certain point in a network, commanding a change of a decision function or a decision threshold at said point or other point.

A thirty-third invention for solving the aforementioned problems is a program for a communication quality determining apparatus for, by receiving or intercepting data sent from a transmission side to a reception side en route of its transmission, determining its communication quality, characterized in that said program causes said communication quality determining apparatus to function as:

deciding unit for making a decision on whether an input packet is to be acquired; and

estimating unit for, by comparing information on an acquired packet predicted based on an acquired packet acquired based on a result of said decision with information on an actually acquired packet, estimating communication quality of a session that said acquired packet belongs to.

A thirty-fourth invention for solving the aforementioned problems is a program for a communication quality determining apparatus for, by receiving or intercepting data sent from a transmission side to a reception side en route of its transmission, determining its communication quality, characterized in that said program causes said communication quality determining apparatus to function as:

identifying unit for identifying a protocol that an input packet belongs to;

deciding unit for making a decision on whether said input packet is to be acquired based on said identified protocol; and

estimating unit for, by comparing information on an acquired packet acquired based on a result of said decision with information on an actually acquired packet, estimating communication quality of session that said acquired packet belongs to solely from said acquired packet.

The communication quality determining apparatus in accordance with the present invention has: a sampling processing section and a sampling database; and an SN number checking section, a sampling database, an SN missing number counting section and a missing number statistic processing section, and is capable of calculating an index regarding a packet loss and a delay for a protocol having a field that varies from packet to packet and that allows prediction of the contents of a packet that will arrive in the future, by unit of sampling determination.

This mechanism will now be particularly explained with reference to FIG. 9.

<FIG. 9, Step 1>

In a sampling processing section 105d, a sampling decision is made based on a predictable field, for example, a sequence number of UDP/RTP, in an acquired packet. A sampling method involves generating random numbers from a random number generating function in a sampling database 106d based on the sequence number of a packet from a data capturing section 101.

<FIG. 9, Step 2>

The generated random number is compared with a sampling probability in the sampling database 106d, and a decision is made such that acquisition will be effected if the generated random number is smaller, and no acquisition will be effected if the generated random number is larger, according to (3):

[Condition for Packet Acquisition]

Sampling probability>Random number generating function(Sequence number) (3)

Thus, the number of packets that are actually sampled for observation and their sequence numbers can be known.

<FIG. 9, Step 3>

Next, the processing in an SN number checking section 201d, a sampling database 206d, and an SN missing number counting section 202d involves reading a sequence number of a first packet in a flow currently subjected to quality determination, generating a random number from the random number generating function in the sampling database 206d against a sequence number expected to arrive thereafter, and performing the calculation according to (3). Consequently, a sequence number of a packet that would be observed if the packet is not lost in the network can be predicted.

Thus, a packet that is actually acquired at the sampling processing section is compared with a packet that is ideally acquired by the SN number checking section, and a decision can be made such that a packet loss has occurred if a difference is made, and no packet loss has occurred if no difference is made.

<FIG. 9, Step 4>

Since the number of packet losses has been predicted from among packets sampling-determined up to STEP 3, statistic processing is applied to calculate an expected value for packet losses. Particular equations (4)-(6) are given as follows:

[Expected Value for a Packet Loss Count]

Expected value for a packet loss count=SN missing number/Sampling probability (4)

[Expected Value for a Throughput]

Expected value for a throughput=(Number of packets received without being lost+SN missing number)/Sampling probability (5)

[Expected Value for a Packet Loss Rate]

Expected value for a packet loss rate=Expected value for a packet loss count/Expected value for a throughput (6)

As a result, the quality can be accurately determined even in a case that not all packets in a flow to be determined can be acquired.

Another result is that only part of packets flowing through the network can be determined to determine an index regarding the quality, thus eliminating the need of high computational processing capability in the determining apparatus, observer, or determination server.

Still another result is that sampling determination allows the communication traffic to be significantly reduced even in a case that acquired packets or part thereof are thrown from an observer to a determination server, thus reducing a load imposed on a network.

Still another effect is that, even when packets or part thereof are exchanged between the observer and determination server, the traffic is reduced, whereby the determination server, instead of the observer, can perform flow identification or computational processing regarding the quality, thus achieving reduction in size and cost of the observer.

Moreover, the communication quality determining apparatus in accordance with the present invention has: a sampling processing section 105d and a sampling database 106d; an SN number checking section 201d, a sampling database 206d, an SN missing number counting section 202d and a missing number statistic processing section 203d; and a packet number comparing section 304e, and with respect to the quality such as a “throughput” or a “packet loss” for a protocol having a field that varies from packet to packet and that allows prediction of the contents of a packet that will arrive in the future by means of sampling determination, the apparatus is capable of affirming a performance change, in spite of the sampling determination, when a change in such quality occurs among the observers.

This mechanism will now be particularly explained with reference to FIG. 10.

For simplification, it is assumed in FIG. 10 that only even sequence numbers are acquired as a result of reference to a sampling database. The observer performs sampling determination, and since reference is made to a sampling database in this sampling scheme, exactly the same packet should be basically observed in the observer 1 through 4 if the observers have identical databases. In a case that any change has nevertheless occurred, it is thought that a change in quality has occurred there. The usual sampling scheme having no sampling database does not allow for affirmation of a change in quality by merely observing a change in sequence number or packet number because when a plurality of observers are provided they do not always observe the same packet.

### EFFECTS OF THE INVENTION

A first effect of the present invention is that high computational capability is not required in the quality determination system.

This is because the present invention allows an index regarding a loss to be calculated by merely acquiring part of a packet stream, thus significantly reducing the number of packets to be calculated in the quality determination system.

A second effect of the present invention is that it is possible to estimate an index regarding a loss such as a loss rate, a loss count, bursting of losses, and lost packet numbers, with high accuracy in the quality determination system even in a case that not all packets can be acquired.

This is because the present invention allows an index regarding a loss to be calculated by merely acquiring part of a packet stream.

A third effect of the present invention is that it is possible to estimate an index regarding a delay such as a delay time, a variation in delay, and a distribution of delay, with high accuracy in the quality determination system even in a case that not all packets can be acquired.

This is because the present invention allows an index regarding a delay to be calculated by merely acquiring part of a packet stream.

A fourth effect of the present invention is that a greater number of observers can be disposed in a network at the cost equivalent to that in the conventional technique.

This is because a costly flow information storage section or database for managing the similar flow condition can be disposed on the determination server side without significantly increasing the traffic between the determination server and observer, thus reducing an implementation load on the observer side.

A fifth effect of the present invention is that c between the determination server and the observer.

This is because: conventionally, when a costly flow information storage section or database for managing the similar flow condition is disposed on the determination server, the data to be transmitted from the observer to the determination server is the whole packet stream being monitored; however, according to the present invention, it is sufficient to transmit only part of the packets being monitored.

### BRIEF DESCRIPTION OF THE DRAWINGS

FIG. 1 is a diagram showing a scope of application of a first conventional method.

FIG. 2 is a block diagram of the first conventional method.

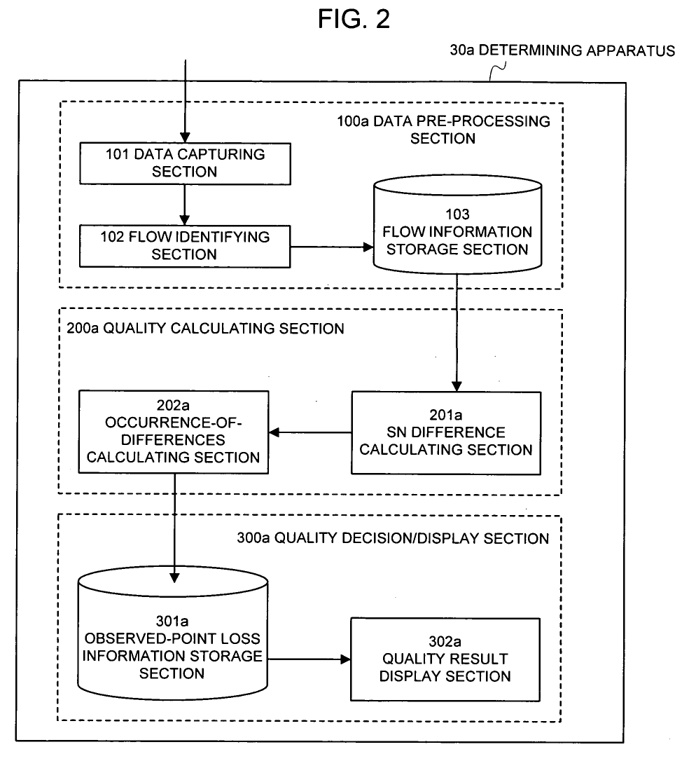

FIG. 3 is a diagram showing processing flow of the first conventional method.

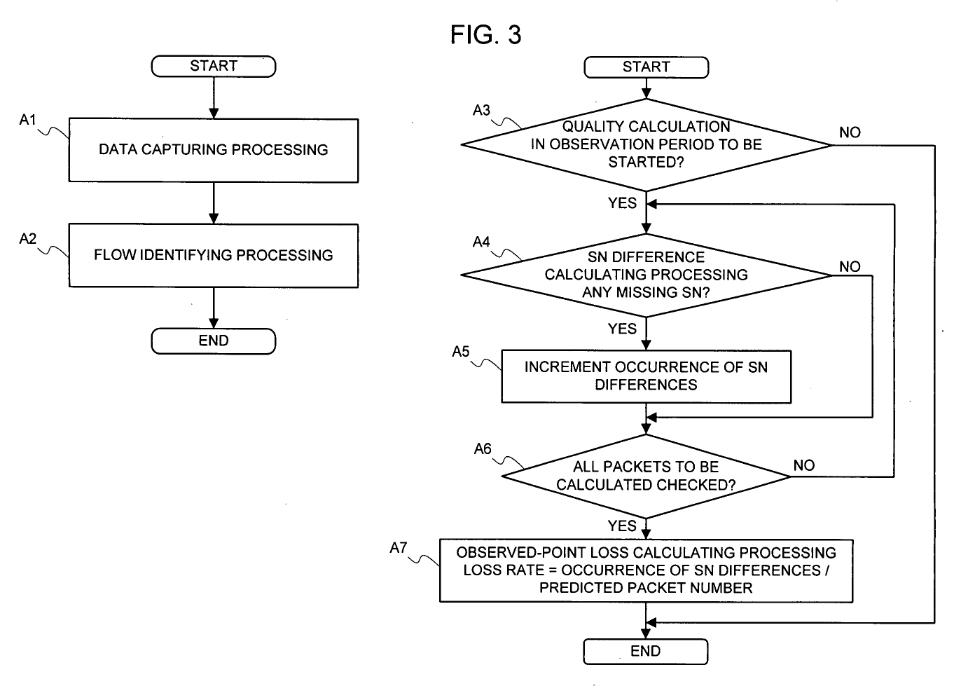

FIG. 4 is a diagram showing a scope of application of a second conventional method.

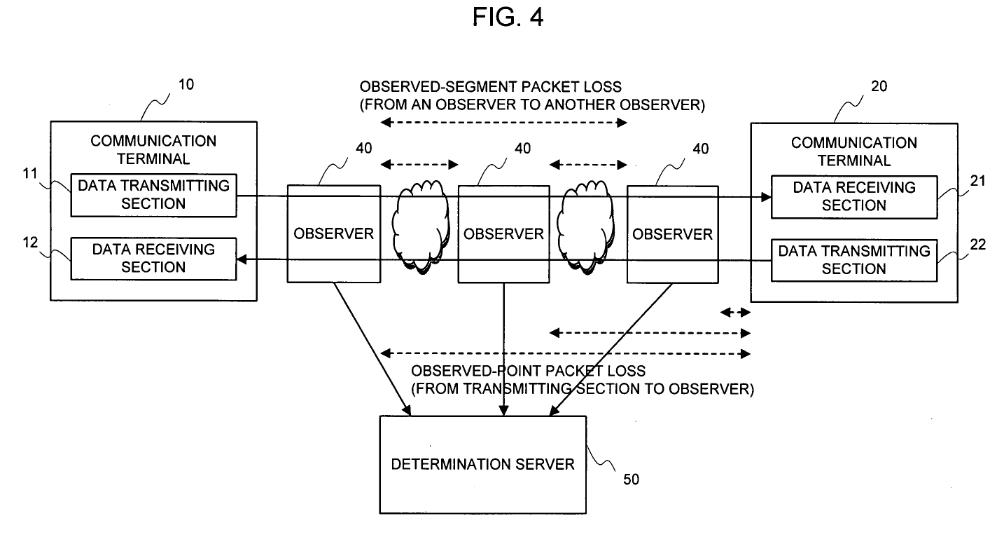

FIG. 5 is a block diagram of the second conventional method.

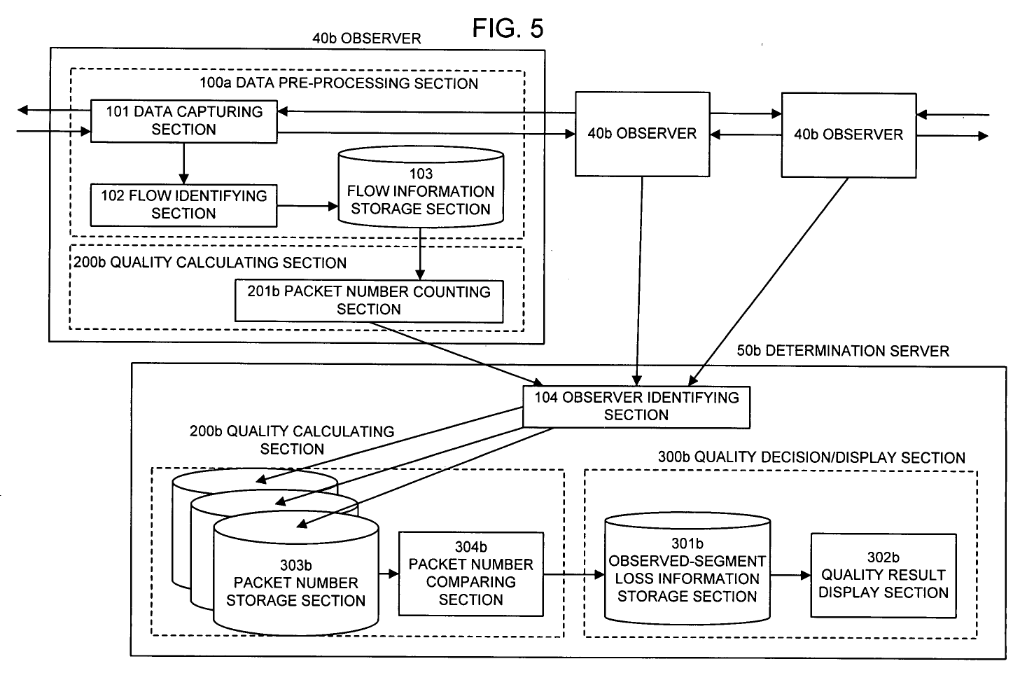

FIG. 6 is a diagram showing processing flow of the second conventional method.

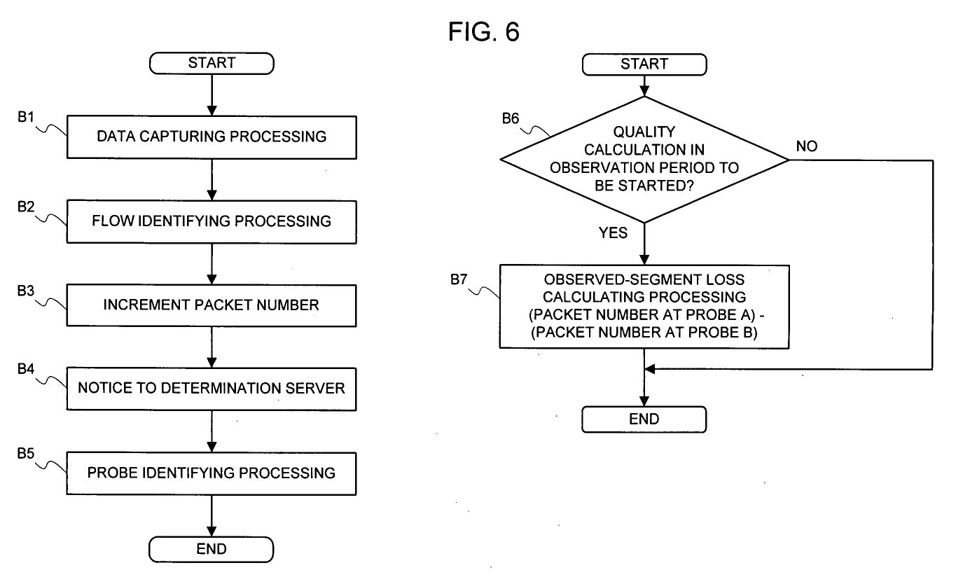

FIG. 7 is a block diagram of a third conventional method.

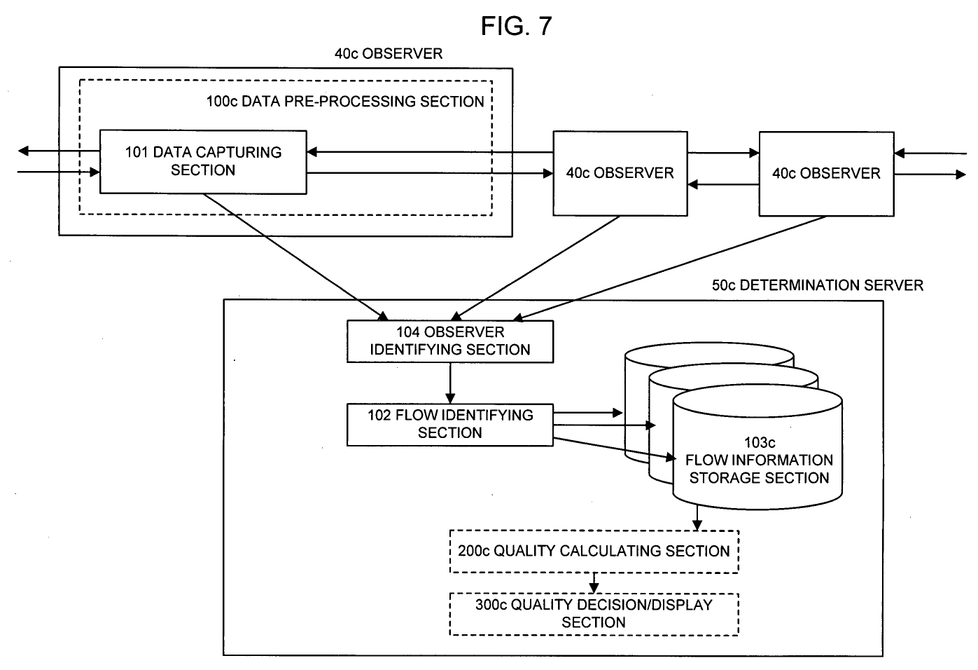

FIG. 8 is a diagram showing processing flow of the third conventional method.

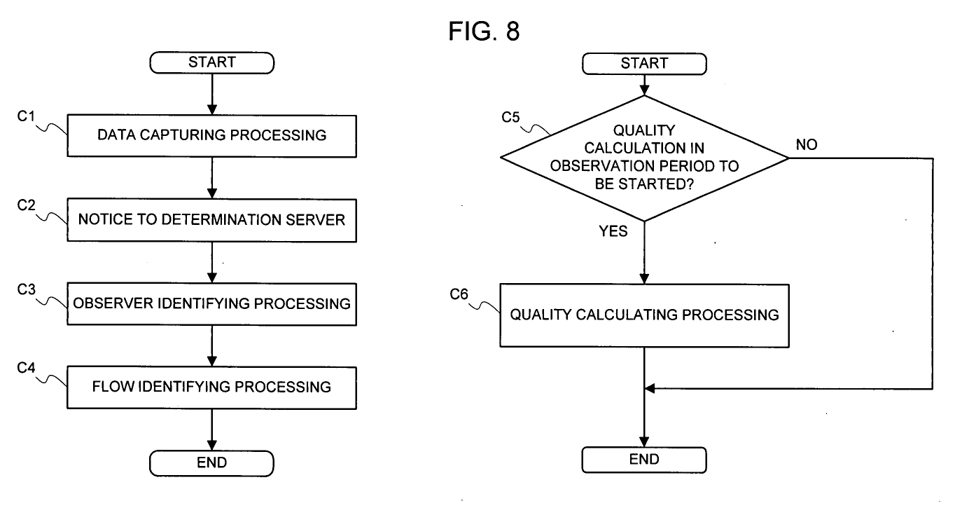

FIG. 9 is a diagram for explaining a method of calculating an observed-point packet loss in accordance with the present invention.

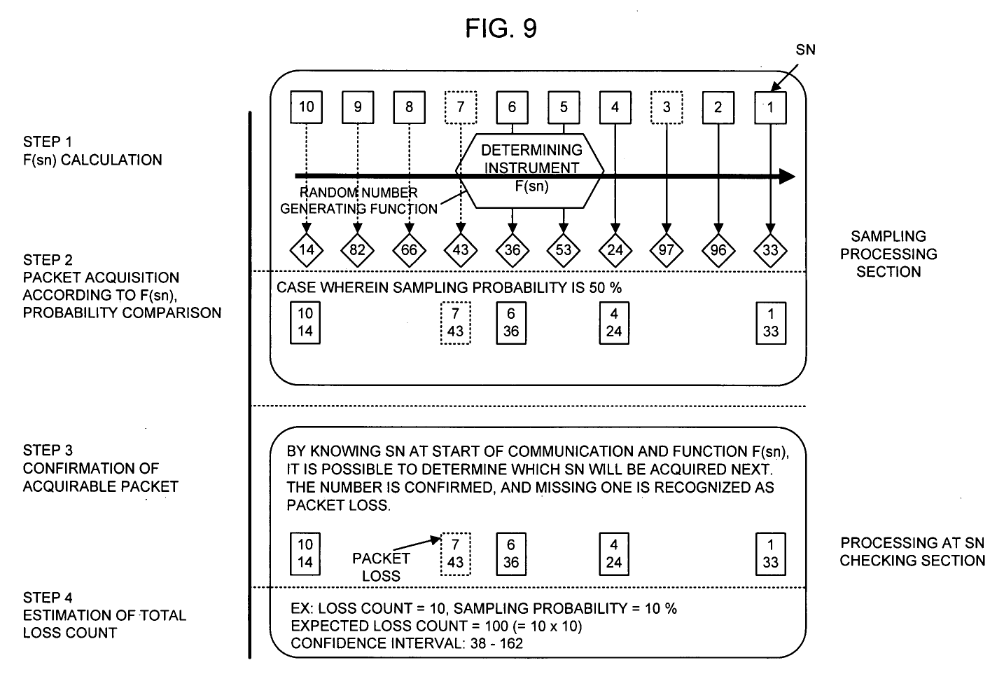

FIG. 10 is a diagram for explaining a method of calculating an observed-segment packet loss in accordance with the present invention.

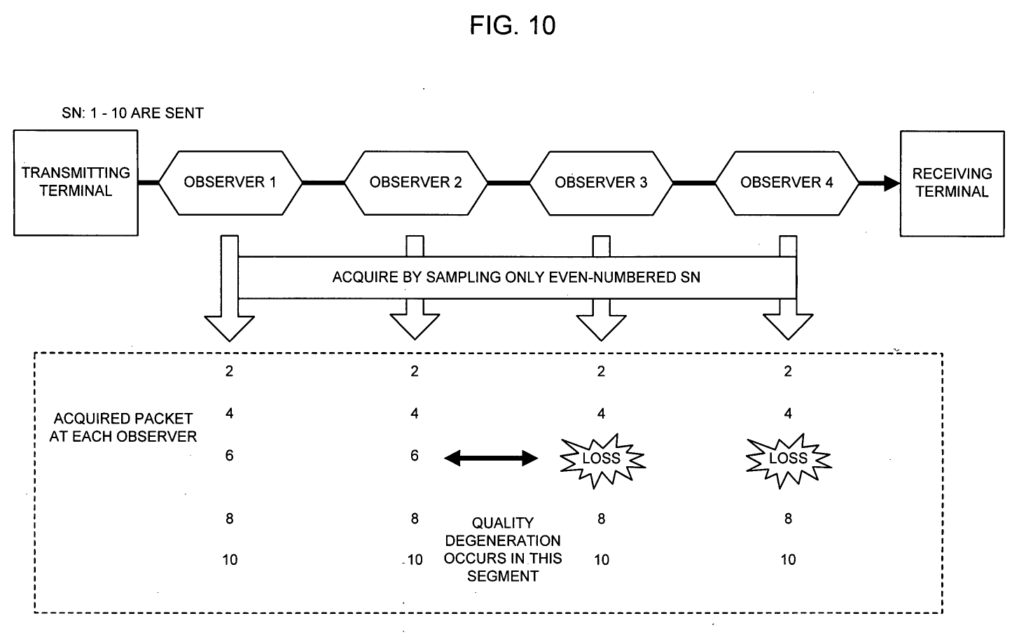

FIG. 11 is a block diagram of a determining apparatus in accordance with a first embodiment.

FIG. 12 is an overview of processing flow in the determining apparatus in accordance with the first embodiment.

FIG. 13 is a block diagram of a determining apparatus in accordance with a second embodiment.

FIG. 14 is an overview of processing flow in the determining apparatus in accordance with the second embodiment.

### EXPLANATION OF SYMBOLS

30 Determining apparatus
100 Data pre-processing section
200 Quality calculating section
300 Quality decision/display section

### BEST MODES FOR CARRYING OUT THE INVENTION

### Explanation of Configuration

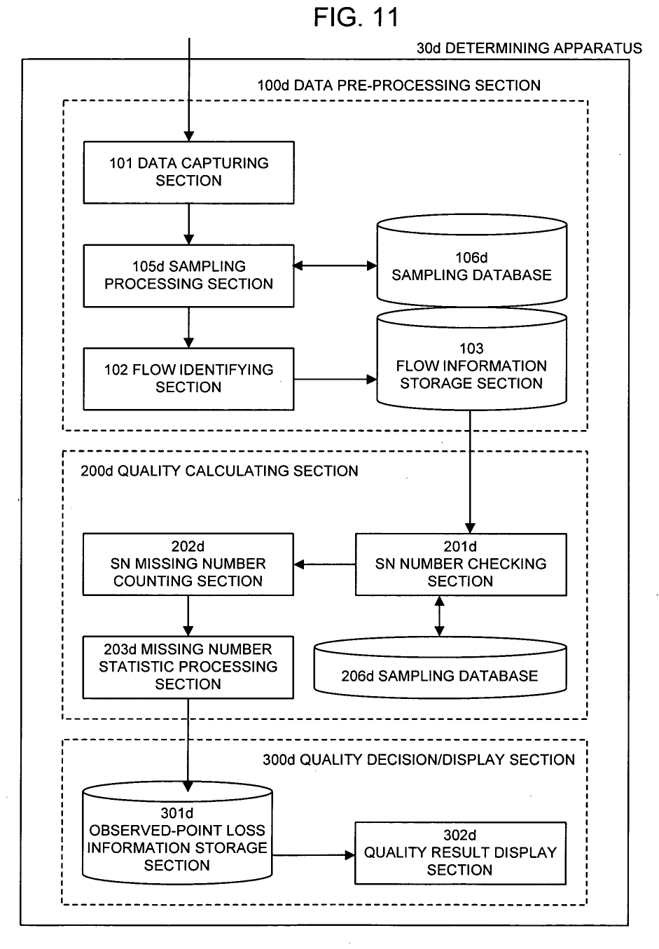

FIG. 11 is a block diagram showing a configuration with a determining apparatus 30d according to a first embodiment.

The present invention is a method of calculating an index regarding an observed-point packet loss from a data transmitting terminal to an observed point with respect to a protocol having a field that varies from packet to packet and that allows prediction of the contents of a packet that will arrive in the future.

As a typical example of the field that varies from packet to packet and that allows prediction of the contents of a packet that will arrive in the future, there is a sequence number of a packet.

As a typical example of the protocol having a sequence number that allows prediction of the contents of a packet that will arrive in the future, there is a UDP/RTP protocol. Accordingly, the following explanation will be made with reference to UDP/RTP for simplification.

The determining apparatus 30d of the first embodiment is comprised of a data capturing section 101 for copying and acquiring a packet during communication in a network, a sampling processing section 105d for sampling a stream of captured data, a sampling database 106d for the sampling processing section 105d to refer to in sampling processing, a flow identifying section 102 for identifying a flow of the packet acquired by the sampling processing section 105d, a flow information storage section 103 for storing flow-identified data on a flow-by-flow basis, an SN number checking section 201d for checking information in the flow information storage section 103 with that in a sampling database 206d, an SN missing number counting section 202d for counting the number of missing SN's from a result of the checking, a missing number statistic processing section 203d for performing statistic processing on the missing SN count to estimate an index regarding an original packet loss from a result of sampling processing, an observed-point loss information storage section 301a for storing the estimated index regarding a packet loss on a flow-by-flow basis, and a quality result display section 302a for displaying the result.

In the first embodiment, data flowing through a network is captured by the determining apparatus 30d. The packet input to the determining apparatus 30d is first received at the data capturing section 101. The data received at the data capturing section 101 is passed to the sampling processing section 105d. The sampling processing section 105 extracts a part of packets from the whole packet stream referring to the information on the packets passed from the data capturing section 101 and to the sampling database 106d. The following processing is applied only to the packets extracted here.

The sampling processing here involves a sampling decision based on a sequence number of UDP/RTP.

A method of sampling decision involves generating random numbers from a random number generating function in the sampling database 106d based on the sequence number of the packet transmitted from the data capturing section 101, and comparing the random number with a sampling probability in the sampling database 106d to make a decision such that acquisition will be effected if the random number is smaller, and no acquisition will be effected if the random number is larger, according to (3):

[Condition for Packet Acquisition]

Sampling probability>Random number generating function(Sequence number) (3)

After the sampling processing is completed, packets to be acquired are selected and the acquired packets are passed to the flow identifying section 102. The flow identifying section 102 identifies a flow based on header information including an MAC address, an IP address, a TCP port number, a UDP port number, protocol ID, VLAN, MPLS, etc. The flow identifying section 102 accumulates results of the flow identification into the flow information storage section 103, which serves as a database having the results classified on a flow-by-flow basis.

Triggered by a command or timing or the like for quality determination, the data in the flow information storage section 103 are sorted by SN of an RTP packet by the SN number checking section 201d on a flow-by-flow basis, and the result is compared with the sampling database 206d.

The checking processing here involves reading a sequence number of a first packet in a flow currently subjected to quality determination and stored in the flow information storage section 103, generating a random number from a random number generating function in the sampling database 206d against a sequence number expected to arrive thereafter, and performing the calculation according to (3). Consequently, a sequence number of a packet that would be observed if the packet is not lost in the network is predicted. By comparing the packet of the sequence number thus predicted with a sequence number of the packet stored in the flow information storage section 103 or with a packet number, the presence or absence of a packet loss in the sampling observation is surveyed.

If a packet loss is found during the checking processing, the number of packets received without being lost and the number of packets confirmed to be lost are counted at the SN missing number counting section 202d, and the value in the SN missing number counting section is passed to the missing number statistic processing section 203d in a unit for calculating the quality such as period of observation or flow etc.

By recording here the sequence number at which a packet data loss occurs, the data lost number can be known.

Moreover, by confirming here whether a packet data loss consecutively occurs, the frequency of bursting of data losses can be known. This is achieved by using a table for returning bursting of communication losses with a key representing the number of consecutively lost packets that would be otherwise acquired.

The missing number statistic processing section 203d calculates an index regarding an observed-point packet loss from the transmitting terminal to the determining apparatus according to the statistic processing of (4)-(6):

[Expected Value for a Packet Loss Count]

Expected value for a packet loss count=SN missing number/Sampling probability (4)

[Expected Value for a Throughput]

Expected value for a throughput=(Number of packets received without being lost+SN missing number)/Sampling probability (5)

[Expected Value for a Packet Loss Rate]

Expected value for a packet loss rate=Expected value for a packet loss count/Expected value for a throughput (6)

After the processing at the missing number statistic processing section 203d is completed, the result is stored in the observed-point loss information storage section 301d. Triggered by a command from a user or timing or the like, the quality result display section 302d displays the flow-by-flow packet loss information stored in the observed-point loss information storage section 301d.

<Explanation of Operation>

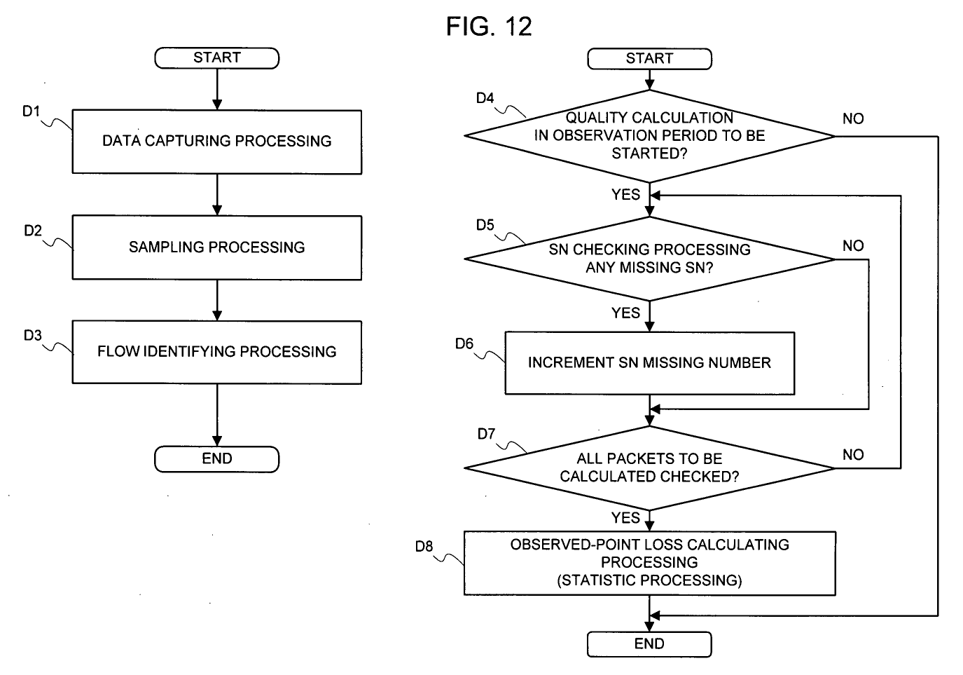

FIG. 12 shows a processing flow at the determining apparatus 30d according to the first embodiment.

At the determining apparatus 30d of the first embodiment, processing is activated each time a packet is input, whereupon packet capturing processing is conducted at the packet capturing section 101. This processing is processing D-1. After this processing is completed, the process moves to processing D-2.

At the processing D-2, packet sampling processing is conducted at the sampling processing section 105d. Specifically, the sampling processing section 105d generates a random number from a random number generating function in the sampling database 106d based on the sequence number of the UDP/RTP packet obtained from the data capturing section 101, and the random number is compared with a sampling probability in the sampling database 106d to make a decision such that acquisition will be effected if the random number is smaller, and no acquisition will be effected if the random number is larger, according to (3). Thereafter, several kinds of processing are applied only to the acquired packets. After the processing, the process moves to processing D-3.

At the processing D-3, flow identification is conducted on the input packet at the flow identifying section 102. The flow identification is made based on header information of the packet including an MAC address, an IP address, a TCP port number, a UDP port number, protocol ID, VLAN, MPLS, etc., and a result thereof is stored into the flow information storage section 103.

Processing D-4 is started being trigged by a command or timing or the like for quality determination. Upon the start of the processing, the process moves to processing D-5.

The processing D-5 is conducted by the SN number checking section 201d. The data in the flow information storage section 103 are sorted by the sequence number of an RTP packet on a flow-by-flow basis, and the result is compared with the sampling database 206d.

The comparing processing here involves reading a sequence number of a first packet in a flow currently subjected to quality determination and stored in the flow information storage section 103, generating a random number from a random number generating function in the sampling database 206d against a sequence number expected to arrive thereafter, and performing the calculation according to (3). Consequently, a sequence number of a packet that would be observed if the packet is not lost in the network is predicted. By comparing the packet of the sequence number thus predicted with a sequence number of the packet stored in the flow information storage section 103 or with a packet number, the presence or absence of a packet loss in the sampling observation is surveyed. By recording here the sequence number at which a data loss occurs whose packet is detected to be lost, the data lost number can be known. Moreover, by confirming here whether a packet data loss consecutively occurs, the frequency of bursting of data losses can be known. This is achieved by using a table that is looked up with a key representing the number of consecutively lost packets that would be otherwise acquired, and returns bursting of communication losses in response thereto. If a packet loss is found, the process goes to processing D-5; otherwise, to processing D-6.

At the processing D-5, if a packet loss is found during the checking processing, the number of packets received without being lost and the number of packets confirmed to be lost are counted at the SN missing number counting section 202d. After the counting is completed, the process moves to the processing D-6.

At the processing D-6, if quality determination is completed for all packets to be currently monitored, the value in the SN missing number counting section is passed to the missing number statistic processing section 203d in a unit for calculating the quality such as period of observation or flow etc., and the process moves to processing D-7; otherwise, the process moves to the processing D-5 to perform a check on the remaining packets.

At processing D-8, the missing number statistic processing section 203d performs statistic processing according to (4)-(6) to calculate an index regarding an observed-point packet loss from the transmitting terminal to the determining apparatus.

The packet loss count or packet loss rate in the observed-point loss information storage section in this system represents the number or rate of packets lost in the network from the packet transmitting terminal to the determining instrument.

Thus, the contents of the processing by the determining apparatus 30d in accordance with the first embodiment of the present invention have been described.

In the related art, means for calculating an index regarding a packet loss acquires all passing-through packets at the determining apparatus 30 to calculate an index regarding a packet loss from dropouts of the sequence number therein. Therefore, when such a calculation technique is applied to sampling determination, it is impossible to discern between discontinuity of the sequence number originating from decimation in sampling and that from a packet loss. Moreover, in a common sampling determination, there have been methods of determination regarding the amount of packets, whereas few methods of calculating an index regarding a packet loss are found. Therefore, the conventional determining apparatus cannot calculate an index regarding a loss by sampling packets. Furthermore, several kinds of processing must be applied to all packets, thus imposing a load to computational processing for calculating quality determination.

On the other hand, this embodiment uses the means for calculating an index regarding a packet loss that performs sampling based on a field that varies from packet to packet and that allows prediction of the content of a packet that will arrive in the future, particularly, a UDP/RTP sequence number field. By using such sampling means, once the first packet has arrived, packets that will be sampled thereafter can be predicted, and the predicted packet and actually arriving packet can be compared to decide the presence or absence of a packet loss in sampling determination. By realizing the sampling determination, it is possible to perform quality determination by merely applying processing to a part of packets, thus reducing a load on computational processing. Moreover, even in a case that failure in packet acquisition occurs at the data capturing section, an index regarding a packet loss can be estimated.

Although this embodiment is explained as generating a random number based on a sequence number field of UDP/RTP for simplification, a sequence number is not necessarily employed insofar as a field that varies from packet to packet and that allows prediction of the content of a packet that will arrive in the future is used. Moreover, a protocol other than UDP/RTP may be employed.

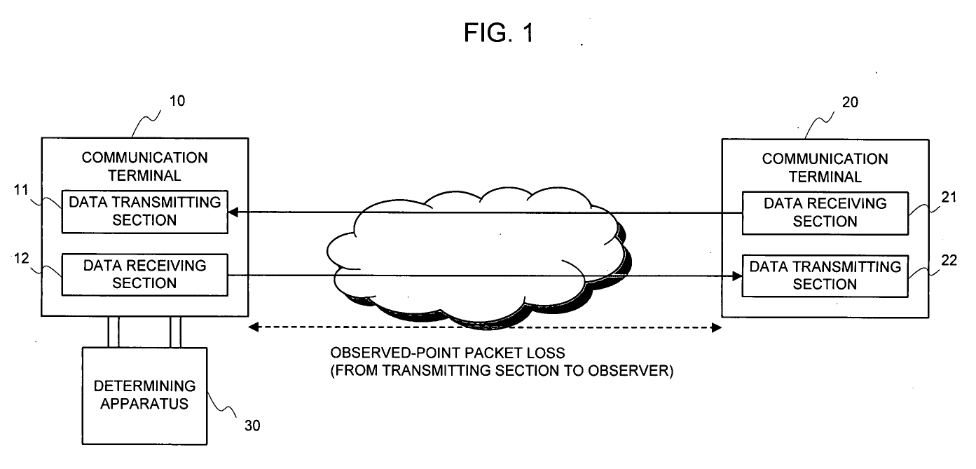

A scope of application of the present invention not only encompasses the condition shown in FIG. 1 in which non-determined network and traffic are unaffected, but it is possible to implement a mode in which data relay terminals are inserted in between communication terminals and which has an effect on the non-determined network and traffic, insofar as such a mode allows data to be acquired. Data relay terminals in such a case include an Ethernet switch for data transfer in Layer 2, a router for data transfer in Layer 4, a gateway for transfer in Layer 4 or higher, etc., and this term refers to a terminal that transfers data without modification or after modification in protocol, or a terminal provided with an additional load balancing function or frequency band control function.

Moreover, the sampling processing section need not be disposed in the determining apparatus 30d as in this embodiment, and it is sufficient to achieve a condition in which the determining apparatus 30d can know the sampling rate. Particularly, this refers to a case in which the packet sampling function is provided in a data relay terminal such as router or switch, or a case in which a packet is input to the determining apparatus 30d through a sampling apparatus for sampling processing.

While the sampling processing section 105d of this embodiment is implemented after the data capturing section 105, the sampling processing implemented before the data capturing section 101 can provide similar effects. Likewise, the sampling processing implemented after the flow identifying section 102 can provide similar effects.

While the sampling databases 106d and 206d of this embodiment are described as containing a random number generating function and performing sampling based thereon, a database that is looked up by a sequence number to give a result of a random number contained therein may be employed. Moreover, additionally taking a sampling probability into account, a database that is looked up by the sampling probability and sequence number to give a result merely representing whether the packet is to be acquired or not may be employed.

While according to this embodiment, only an expected value regarding a packet loss or a packet loss rate is calculated, it is contemplated that a general statistic calculation for determining a confidence interval or an error range is used to determine the confidence interval or an error range regarding the packet loss count or rate.

Next, a second embodiment will be explained hereinbelow.

<Explanation of Configuration>

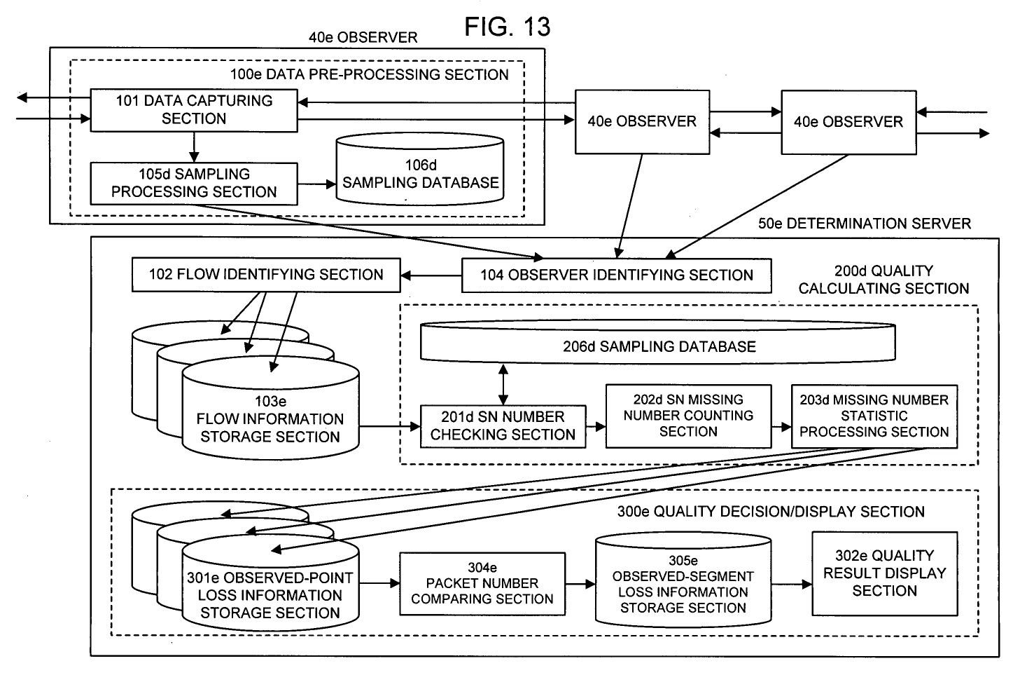

FIG. 13 is a block diagram showing a configuration with an observer 40e and a determination server 50e according to a second embodiment.

The present invention is a method of calculating an index regarding an observed-point packet loss from a data transmitting terminal to an observed point for a protocol having a field that varies from packet to packet and that allows prediction of the content of a packet that will arrive in the future.

As a typical example of the field that varies from packet to packet and that allows prediction of the content of a packet that will arrive in the future, there is a sequence number of a packet.

As a typical example of the protocol having a sequence number that allows prediction of the content of a packet that will arrive in the future, there is a UDP/RTP protocol. Accordingly, the following description will be made with reference to UDP/RTP for simplification.

The observer 40e of the second embodiment is comprised of a data capturing section 101 for copying and acquiring a packet during communication in a network, a sampling processing section 105d for sampling a stream of captured data and sending the result to the determination server, and a sampling database 106d for the sampling processing section 105d to refer to in sampling processing.

The determination server 50e of the second embodiment is comprised of an observer identifying section 104 for acquiring a packet sent from the observer 40e and determining which observer 40 the information comes from, a flow identifying section 102 for identifying a flow of the packet, a flow information storage section 103c for storing flow-identified data on a flow-by-flow basis, an SN number checking section 201d for checking information in the flow information storage section 103 with that in a sampling database 206d, an SN missing number counting section 202d for counting the number of missing SN's from a result of the checking, a missing number statistic processing section 203d for performing statistic processing on the missing SN count to estimate an index regarding an original packet loss from the result of the sampling processing, an observed-point loss information storage section 301e for storing the estimated index regarding a packet loss on a flow-by-flow basis, a packet number comparing section 304e for comparing the index regarding a loss between observers, an observed-segment loss information storage section 305e for storing the result of the comparison, and a quality result display section 302e for displaying the result.

In the second embodiment, data flowing through a network is captured by the observer 40e. The packet input to the observer 40e is first received at the data capturing section 101. The data received at the data capturing section 101 is passed to the sampling processing section 105d. The sampling processing section 105 extracts a part of packets from the whole packet stream referring to the information on the packets passed from the data capturing section 101 and to the sampling database 106d. The following processing is applied only to the packets extracted here.

The sampling processing here involves a sampling decision based on a sequence number of UDP/RTP. The sampling method involves generating random numbers from a random number generating function in the sampling database 106d based on the sequence number of the packet transmitted from the data capturing section 101; and comparing generated random number with a sampling probability in the sampling database 106d to make a decision such that acquisition will be effected if the random number is smaller, and no acquisition will be effected if the random number is larger, according to (3):

[Condition for Packet Acquisition]

Sampling probability>Random number generating function(Sequence number) (3)

After the sampling processing is completed, the sampling processing section 105d transmits the packet information to the determination server 50e.

In the determination server 50e of the second embodiment, the observer identifying section 104 initially identifies which observer 40e the received packet information comes from. This identifying processing can be realized by embedding an ID or the like of the observer into the information to be sent from the observer 40e to the determination server 50e. After completing the observer identifying processing, the result is passed to the flow identifying section 102. The flow identifying section 102 identifies a flow based on header information including an MAC address, an IP address, a TCP port number, a UDP port number, protocol ID, VLAN, MPLS, etc. The flow identifying section 102 accumulates results of the flow identification into the flow information storage section 103e, which serves as a database having the results classified on an observer-by-observer/flow-by-flow basis.

Triggered by a command or timing or the like for quality determination, the data in the flow information storage section 103 are sorted by SN of an RTP packet by the SN number checking section 201d on a flow-by-flow basis, and the result is compared with the sampling database 206d.

The checking processing here involves reading a sequence number of a first packet in a flow currently subjected to quality determination and stored in the flow information storage section 103, generating a random number from a random number generating function in the sampling database 206d against a sequence number expected to arrive thereafter, and performing the calculation according to (3). Consequently, a sequence number of a packet that would be observed if the packet is not lost in the network is predicted. By comparing the packet of the sequence number thus predicted with a sequence number of the packet stored in the flow information storage section 103 or with a packet number, the presence or absence of a packet loss in the sampling observation is surveyed.

If a packet loss is found during the checking processing, the number of packets received without being lost and the number of packets confirmed to be lost are counted at the SN missing number counting section 202d, and the value in the SN missing number counting section is passed to the missing number statistic processing section 203d in a unit for calculating the quality such as period of observation or flow etc.

By recording here the sequence number at which a data loss occurs whose packet is detected to be lost, the data lost number can be known.

Moreover, by confirming here whether a packet data loss consecutively occurs, the frequency of bursting of data losses can be known. This is achieved by using a table for returning bursting of communication losses with a key representing the number of consecutively lost packets that would be otherwise acquired.

The missing number statistic processing section 203d calculates an index regarding an observed-point packet loss from the transmitting terminal to the determining apparatus according to the statistic processing of (4)-(6):

[Expected Value for a Packet Loss Count]

Expected value for a packet loss count=SN missing number/Sampling probability (4)

[Expected Value for a Throughput]

Expected value for a throughput=(Number of packets received without being lost+SN missing number)/Sampling probability (5)

[Expected Value for a Packet Loss Rate]

Expected value for a packet loss rate=Expected value for a packet loss count/Expected value for a throughput (6)

After the processing at the missing number statistic processing section 203d is completed, the result is stored in the observed-point loss information storage section 301e.

The packet number comparing section 304e can calculate the following (7) and (8) to obtain information regarding a packet loss in an observed segment:

[Expected Value for an Observed-Segment Packet Loss Count]

Expected value for an observed-segment packet loss count=|Observed-point packet loss count at an endpoint of an observer to be compared−Packet loss count at the other endpoint|/Sampling probability (7)

[Expected Value for an Observed-Segment Packet Loss Rate]

Expected value for an observed-segment packet loss rate=(Observed-point packet loss count at an endpoint of an observer to be compared−Packet loss count at the other endpoint)/(Total number of packets passing through the two points+|Observed-point packet loss count at an endpoint of an observer to be compared−Packet loss count at the other endpoint|) (8)

Moreover, the following (9) and (10) can be calculated to determine a delay time, a variation in delay, and a distribution of a delay in an observed segment.

[Delay Time in an Observed Segment]

Delay time in an observed segment=|(Pass time at an endpoint of an observer to be compared−Pass time at the other endpoint)| (9)

[Variation in a Delay in an Observed Segment]

Variation in a delay in an observed segment=|(Delay time of a certain sequence number in an observed segment)−(Delay time of a different sequence number in the observed segment)| (10)

The results of the calculations are stored in the observed-segment loss information storage section 305e. Triggered by a command from a user or timing or the like, the quality result display section 302e displays the flow-by-flow packet loss information stored in the observed-point loss information storage section 301e or observed-segment loss information storage section 305e.

<Explanation of Operation>

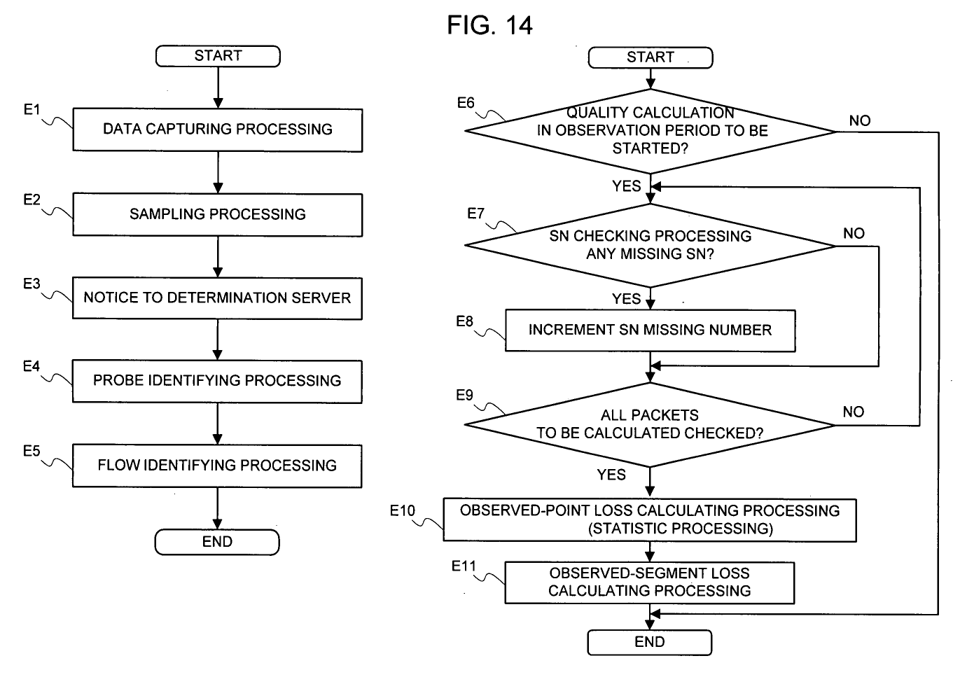

FIG. 14 shows a processing flow at the observer 40e and the determination server 50e according to the second embodiment.

At the observer 40e of the second embodiment, processing is activated each time a packet is input, whereupon packet capturing processing is conducted at the packet capturing section 101. The processing is processing E-1. After this processing is completed, the process moves to processing E-2.

At the processing E-2, packet sampling processing is conducted at the sampling processing section 105d. The sampling processing section 105d generates a random number from a random number generating function in the sampling database 106d based on the sequence number of the UDP/RTP packet obtained from the data capturing section 101, and the random number is compared with a sampling probability in the sampling database 106d to make a decision such that acquisition will be effected if the random number is smaller, and no acquisition will be effected if the random number is larger, according to (3). Thereafter, several kinds of processing are applied only to the acquired packets. After the processing, the process moves to processing E-3.

At the processing E-3, the packet sampled and acquired by the sampling processing section 105d is transmitted to the determination server 50e. After this processing is completed, the process moves to processing E-4.

At the processing E-4, the incoming packet into the determination server 50e is identified as to which observer 40e the packet comes from. The process next moves to processing E-5.

At the processing E-5, flow identification is conducted on the input packet at the flow identifying section 102. The flow identification is made based on header information of the packet including an MAC address, an IP address, a TCP port number, a UDP port number, protocol ID, VLAN, MPLS, etc., and a result thereof is stored into the flow information storage section 103e on an observer-by-observer/flow-by-flow basis.

Processing E-6 is started being trigged by a command or timing or the like for quality determination. Upon the start of the processing, the process moves to processing E-7.

The processing E-7 is conducted by the SN number checking section 201d. The data in the flow information storage section 103 are sorted by the sequence number of an RTP packet on a flow-by-flow basis, and the result is compared with the sampling database 206d.

The comparing processing here involves reading a sequence number of a first packet in a flow currently subjected to quality determination and stored in the flow information storage section 103, generating a random number from a random number generating function in the sampling database 206d against a sequence number expected to arrive thereafter, and performing the calculation according to (3). Consequently, a sequence number of a packet that would be observed if the packet is not lost in the network is predicted. By comparing the packet of the sequence number thus predicted with a sequence number of the packet stored in the flow information storage section 103 or with a packet number, the presence or absence of packet loss in the sampling observation is surveyed. By recording here the sequence number at which a data loss occurs whose packet is detected to be lost, the data lost number can be known. Moreover, by confirming here whether a packet data loss consecutively occurs, the frequency of bursting of data losses can be known. This is achieved by using a table for returning bursting of communication losses with a key representing the number of consecutively lost packets that would be otherwise acquired. If a number of packet losses is found, the process goes to processing E-8; otherwise, to processing E-9.

At the processing E-8, if a packet loss is found during the checking processing, the number of packets received without being lost and the number of packets confirmed to be lost are counted at the SN missing number counting section 202d. After the counting is completed, the process moves to the processing E-9.

At the processing E-9, if quality determination is completed for all packets to be currently monitored, the value in the SN missing number counting section is passed to the missing number statistic processing section 203d in a unit for calculating the quality such as period of observation or flow etc., and the process moves to processing E-10; otherwise, the process moves to the processing E-7 to perform a check on the remaining packets.

At the processing E-10, the missing number statistic processing section 203d performs statistic processing according to (4)-(6) to calculate an index regarding an observed-point packet loss from the transmitting terminal to the determining apparatus. The result of the calculation is stored in the observed-point loss information storage section 301e, and the process moves to processing E-11.

At the processing E-11, observed-point loss information of an observer that is an endpoint between the observers for observing the quality are compared by the packet number comparing section 304e, and (7) and (8) are calculated to determine observed-segment loss information. Moreover, (9) and (10) are calculated to obtain information on the observed-segment delay time, the variation in a delay, and the distribution of a delay. The results of these are stored in the observed-segment loss information storage section 305e, and the quality information is displayed by the quality result display section 302e based on a command from a user or set timing or the like.

The packet loss count or packet loss rate in the observed-point loss information storage section in this system represents the number or rate of packets lost in the network from the packet transmitting terminal to the determining apparatus.

The packet loss count or packet loss rate in the observed-segment loss information storage section in this system represents the number or rate of packets lost in the network from a certain observer to the other observer to be compared.

Thus, the contents of the processing by the observer 40e and the determination server 50e in accordance with the second embodiment of the present invention have been described.

In the related art, means for calculating an index regarding a packet loss acquires all passing-through packets at the determining apparatus 30 to calculate an index regarding a packet loss from dropouts of the sequence number therein. Therefore, when such a calculation technique is applied to sampling determination, it is impossible to discern between discontinuity of the sequence number originating from decimation in sampling and that from a packet loss. Moreover, in a common sampling determination, there have been methods of determination regarding the amount of packets, whereas few methods of calculating an index regarding a packet loss are found. Therefore, the conventional determining apparatus cannot calculate an index regarding a loss by sampling packets. Furthermore, several kinds of processing must be applied to all packets, thus imposing a load to computational processing for calculating quality determination.

Moreover, in the conventional technique, information obtained by sampling determination generally represents an expected value. Therefore, since estimation of the quantity of flow passing through two observers, for example, gives a result of an expected value, it is not possible to affirm a change of the quantity of flow by merely comparing the values for the two observers. Thus, in general, comparison between observers is not allowed by using sampling determination.

On the other hand, this embodiment uses the means for calculating an index regarding a packet loss that performs sampling based on a field that varies from packet to packet and that allows prediction of the contents of a packet that will arrive in the future, particularly, a UDP/RTP sequence number field. By using such sampling means, once the first packet has arrived, packets that will be sampled thereafter can be predicted, and the predicted packet and actually arriving packet can be compared to decide the presence or absence of a packet loss in sampling determination. By realizing the sampling determination, it is possible to perform quality determination by merely applying processing to a part of packets, thus reducing a load on computational processing. Moreover, even in a case that failure in packet acquisition occurs at the data capturing section, an index regarding a packet loss can be estimated.

Furthermore, according to this embodiment, precisely the same packets are observed by all observers when their respective sampling databases have the same contents, and therefore, a packet that would be observed by a certain observer if no loss has occurred should be observed by other observers. Paying attention to this nature, in a case that a difference is made between the resulting values from the observers, it is possible to affirm occurrence of a difference between packet numbers or packet losses in that segment in spite of the fact that the result obtained by sampling determination is an expected value, and in turn, it is possible to compare packet numbers or packet loss counts or rates in an observed segment.

Although this embodiment is described as generating a random number based on a sequence number field of UDP/RTP for simplification, a sequence number is not necessarily employed insofar as a field that varies from packet to packet and that allows prediction of the contents of a packet that will arrive in the future is used. Moreover, a protocol other than UDP/RTP may be employed.

A scope of application not only encompasses the condition shown in FIG. 1 in which non-determined network and traffic are unaffected, but it is possible to implement a mode in which data relay terminals are inserted in between communication terminals and which has an effect on the non-determined network and traffic, insofar as such a mode allows data to be acquired. Data relay terminals in such a case include an Ethernet switch for data transfer in Layer 2, a router for data transfer in Layer 4, a gateway for transfer in Layer 4 or higher, etc., and this term refers to a terminal that transfers data without modification or after modification in protocol, or a terminal provided with an additional load balancing function or a frequency band control function.

Moreover, the sampling processing section need not be stand-alone as an observer 40e as in this embodiment, and the packet sampling function may be provided in a data relay terminal such as a router or a switch.

While the sampling processing section 105d of this embodiment is implemented after the data capturing section 105, the sampling processing implemented before the data capturing section 101 can provide similar effects.

While the flow identifying processing of this embodiment is implemented after the observer identifying processing, similar effects can be obtained even when the order is reversed.

While the sampling databases 106d and 206d of this embodiment are described as containing a random number generating function and performing sampling based thereon, a database that is looked up by a sequence number to give a result of a random number contained therein may be employed. Moreover, additionally taking a sampling probability into account, a database that is looked up by the sampling probability and sequence number to give a result merely representing whether the packet is to be acquired or not may be employed.

While according to this embodiment, only an expected value regarding a packet loss or packet loss rate is calculated for an observed-point packet loss index or an observed-segment packet loss index, it is contemplated that a general statistic calculation for determining a confidence interval or an error range is used to determine the confidence interval or an error range regarding the packet loss count or rate.

According to this embodiment, when a packet acquired by the sampling processing section 105d is transmitted to the determination server 50e, the packet is transmitted on a packet-by-packet basis; however, information on a plurality of packets may be transmitted together by accumulating the packets for a certain period of time or for a certain amount, or while modifying the amount of accumulation depending upon the condition of the network. At that time, all packets need not be transmitted but only part of packets may be transmitted when a UDP/RTP sequence field (or predictable field) is involved.

In the aforementioned configurations, similar functions or operations to those in the aforementioned embodiments may be implemented also by means of a processor run by a program, a memory storing information and a storage medium.

1. A communication quality determining apparatus for, by receiving or intercepting data sent from a transmission side to a reception side en route of its transmission, determining its communication quality, comprising:
deciding unit for making a decision on whether an input packet is to be acquired; and
estimating unit for, by comparing information on an acquired packet predicted based on an acquired packet acquired based on a result of said decision with information on an actually acquired packet, estimating communication quality of a session that said acquired packet belongs to.

2. A communication quality determining apparatus for, by receiving or intercepting data sent from a transmission side to a reception side en route of its transmission, determining its communication quality, comprising:
identifying unit for identifying a protocol that an input packet belongs to;
deciding unit for making a decision on whether said input packet is to be acquired based on said identified protocol; and
estimating unit for, by comparing information on an acquired packet acquired based on a result of said decision with information on an actually acquired packet, estimating communication quality of a session that said acquired packet belongs to solely from said acquired packet.

3. A communication quality determining apparatus recited in claim 1, wherein:
said estimating unit is configured to estimate, as communication quality, a data loss count, a data loss rate, continuity of data loss, a data loss number, a predicted range of a data loss count, a throughput, a predicted range of a throughput, a delay time, a variation in delay or a distribution of delay for each session.

4. A communication quality determining apparatus recited in claim 2, wherein:
said identifying unit is configured to identify TCP, UDP/RTP or a protocol containing sequence information in header information.

5. A communication quality determining apparatus recited in claim 1, wherein:
said deciding unit is configured to decide whether an input packet is to be acquired using sequence information contained in header information of the input packet.

6. A communication quality determining apparatus recited in claim 5, wherein:
said deciding unit is configured to have a decision function for deriving a packet acquisition deciding value using a function, pseudo random numbers or a result of looking-up of a table, with an argument of said sequence information, and to decide whether a packet is to be acquired by comparing a value of said decision function and a predefined decision threshold.

7. A communication quality determining apparatus recited in claim 1, wherein:
said estimating unit is configured to calculate a throughput using a difference in acquisition time and a difference in sequence information between a packet acquired in the past and a packet acquired thereafter.

8. A communication quality determining apparatus recited in claim 1, wherein:
said estimating unit is configured to, with respect to specific sequence information, calculate a data loss count or a data loss rate by calculating sequence information of a packet to be acquired next from a decision function given to said protocol, and comparing said sequence information with that of an actually acquired new packet.

9. A communication quality determining apparatus recited in claim 1, wherein:
said estimating unit is configured to obtain a conditional probability that, with respect to a certain discarded packet, a subsequent packet away from said discarded packet by N of sequence information is discarded, using statistics of a difference between sequence information of a packet decided to be discarded in the past and that of a packet decided to be discarded thereafter.

10. A communication quality determining apparatus recited in claim 1, wherein:
said estimating unit is configured to obtain an error range of a data loss count or a throughput using at least one of the numbers of samples, an observation period and a sampling probability, based on an actually occurring data loss count.

11. A communication quality determining apparatus recited in claim 1, wherein:
a plurality of said deciding unit or said estimating unit are provided;
said deciding unit has transmitting unit for transmitting a part of a copy, header information or payload information of a decided and acquired packet to said estimating unit; and
said estimating unit is configured to estimate communication quality of a session that the acquired packet belongs to from said transmitted acquired packet or from information associated with said acquired packet.

12. A communication quality determining apparatus recited in claim 11, wherein:
said deciding unit is configured to unite a plurality of acquired packets or information associated therewith into one packet.

13. A communication quality determining apparatus recited in claim 11, wherein:
said estimating unit is configured to specify a segment in which packet discarding has occurred by comparing deciding unit that could acquire a packet having sequence information and deciding unit that could not acquire a packet having sequence information.

14. A communication quality determining apparatus recited in claim 11, wherein:
said estimating unit is configured to determine a delay time between specific deciding unit by obtaining a delay time obtained by certain deciding unit from a packet having certain sequence information and a delay time obtained by other deciding unit from said packet, and comparing them.

15. A communication quality determining apparatus recited in claim 11, wherein:
said estimating unit is configured to, depending upon an amount of acquired packets transmitted from certain deciding unit, command a change of a decision function or a decision threshold in said deciding unit.

16. A communication quality determining apparatus recited in claim 11, wherein:
said estimating unit is configured to, upon detection of a change in quality at certain deciding unit, command a change of a decision function or a decision threshold to said deciding unit or other deciding unit.

17. A communication quality determining method of, by receiving or intercepting data sent from a transmission side to a reception side en route of its transmission, determining its communication quality, comprising:
a deciding step of making a decision on whether an input packet is to be acquired; and
an estimating step of, by comparing information on an acquired packet predicted based on an acquired packet acquired based on a result of said decision with information on an actually acquired packet, estimating communication quality of a session that said acquired packet belongs to.

18. A communication quality determining method of, by receiving or intercepting data sent from a transmission side to a reception side en route of its transmission, determining its communication quality, comprising:
an identifying step of identifying a protocol that an input packet belongs to;
a deciding step of making a decision on whether said input packet is to be acquired based on said identified protocol; and
an estimating step of, by comparing information on an acquired packet acquired based on a result of said decision with information on an actually acquired packet, estimating communication quality of a session that said acquired packet belongs to solely from said acquired packet.

19. A communication quality determining method recited in claim 17, wherein:
said estimating step is a step of estimating, as communication quality, a data loss count, a data loss rate, continuity of data loss, a data loss number, a predicted range of a data loss count, a throughput, a predicted range of a throughput, a delay time, a variation in delay or a distribution of delay for each session.

20. A communication quality determining method recited in claim 18, wherein:
said identifying step is a step of identifying TCP, UDP/RTP or a protocol containing sequence information in header information.

21. A communication quality determining method recited in claim 17, wherein:
said deciding step is a step of deciding whether an input packet is to be acquired using sequence information contained in header information of the input packet.

22. A communication quality determining method recited in claim 21, wherein:
said deciding step has a deriving step of deriving a packet acquisition deciding value using a function, pseudo random numbers or a result of looking-up of a table, with an argument of said sequence information, and is a step of deciding whether a packet is to be acquired by comparing a derived value of said decision function and a predefined decision threshold.

23. A communication quality determining method recited in claim 17, wherein:
said estimating step is a step of calculating a throughput using a difference in acquisition time and a difference in sequence information between a packet acquired in the past and a packet acquired thereafter.

24. A communication quality determining method recited in claim 17, wherein:
said estimating step is a step of, with respect to specific sequence information, calculating a data loss count or a data loss rate by calculating sequence information of a packet to be acquired next from a decision function given to said protocol, and comparing said sequence information with that of an actually acquired new packet.

25. A communication quality determining method recited in claim 17, wherein:
said estimating step is a step of obtaining a conditional probability that, with respect to a certain discarded packet, a subsequent packet away from said discarded packet by N of sequence information is discarded, using statistics of a difference between sequence information of a packet decided to be discarded in the past and that of a packet decided to be discarded thereafter.

26. A communication quality determining method recited in claim 17, wherein:
said estimating step is a step of obtaining an error range of a data loss count or a throughput using at least one of the number of samples, an observation period and a sampling probability, based on an actually occurring data loss count.

27. A communication quality determining method recited in claim 17, wherein:
said deciding step has a transmitting step of transmitting a part of a copy, header information or payload information of a packet acquired at a plurality of points; and
said estimating step is a step of estimating communication quality of a session that the acquired packet belongs to from said transmitted acquired packet or from information associated with said acquired packet.

28. A communication quality determining method recited in claim 27, wherein:
said deciding step is configured to unite a plurality of acquired packets or information associated therewith into one packet

29. A communication quality determining method recited in claim 27, wherein:
said estimating step is a step of specifying a segment in which packet discarding has occurred by comparing a point at which a packet having sequence information could be acquired and a point at which a packet having sequence information could not be acquired.

30. A communication quality determining method recited in claim 27, wherein:
said estimating step is a step of determining a delay time in a specific segment by obtaining a delay time obtained at a certain point from a packet having certain sequence information and a delay time obtained at other point from said packet, and comparing them.

31. A communication quality determining method recited in claim 27, wherein:
said estimating step has a step of, depending upon an amount of acquired packets transmitted from a certain point, commanding a change of a decision function or a decision threshold at said point.

32. A communication quality determining method recited in claim 27, wherein:
said estimating step has a step of, upon detection of a change in quality at a certain point in a network, commanding a change of a decision function or a decision threshold at said point or other point.

33. A computer readable medium storing a program for a communication quality determining apparatus for, by receiving or intercepting data sent from a transmission side to a reception side en route of its transmission, determining its communication quality, wherein said program causes said communication quality determining apparatus to function as:
deciding unit for making a decision on whether an input packet is to be acquired; and
estimating unit for, by comparing information on an acquired packet predicted based on an acquired packet acquired based on a result of said decision with information on an actually acquired packet, estimating communication quality of a session that said acquired packet belongs to.

34. A computer readable medium storing a program for a communication quality determining apparatus for, by receiving or intercepting data sent from a transmission side to a reception side en route of its transmission, determining its communication quality, wherein said program causes said communication quality determining apparatus to function as:
identifying unit for identifying a protocol that an input packet belongs to;
deciding unit for making a decision on whether said input packet is to be acquired based on said identified protocol; and
estimating unit for, by comparing information on an acquired packet acquired based on a result of said decision with information on an actually acquired packet, estimating communication quality of session that said acquired packet belongs to solely from said acquired packet.

35. A communication quality determining apparatus recited in claim 2, wherein:
said estimating unit is configured to estimate, as communication quality, a data loss count, a data loss rate, continuity of data loss, a data loss number, a predicted range of a data loss count, a throughput, a predicted range of a throughput, a delay time, a variation in delay or a distribution of delay for each session.

36. A communication quality determining apparatus recited in claim 35 wherein:
said identifying unit is configured to identify TCP, UDP/RTP or a protocol containing sequence information in header information.

37. A communication quality determining apparatus recited in claim 2, wherein:
said deciding unit is configured to decide whether an input packet is to be acquired using sequence information contained in header information of the input packet.

38. A communication quality determining apparatus recited in claim 37, wherein:
said deciding unit is configured to have a decision function for deriving a packet acquisition deciding value using a function, pseudo random numbers or a result of looking-up of a table, with an argument of said sequence information, and to decide whether a packet is to be acquired by comparing a value of said decision function and a predefined decision threshold.

39. A communication quality determining method recited in claim 18, wherein:
said estimating step is a step of estimating, as communication quality, a data loss count, a data loss rate, continuity of data loss, a data loss number, a predicted range of a data loss count, a throughput, a predicted range of a throughput, a delay time, a variation in delay or a distribution of delay for each session.

40. A communication quality determining method recited in claim 18, wherein:
said identifying step is a step of identifying TCP, UDP/RTP or a protocol containing sequence information in header information.
